(19) United States
(12) Patent Application Publication
(10) Pub. No.: US 2004/0092228 A1
(43) Pub. Date: May 13, 2004

(54) Apparatus and method for enabling use of low power satellites, such as C-band, to broadcast to mobile and non-directional receivers, and signal design therefor

(76) Inventors: Charles T. Force, Tracy's Landing, MD (US); Stephen J. Horan, Las Cruces, NM (US); Fred W. Herold, Kensington, MD (US)

Correspondence Address: BACON & THOMAS, PLLC, 625 SLATERS LANE, FOURTH FLOOR, ALEXANDRIA, VA, 22314

(21) Appl. No.: 10/699,639

(22) Filed: Nov. 4, 2003

Related U.S. Application Data
(60) Provisional application No. 60/424,605, filed on Nov. 7, 2002.

(51) Int. Cl. H04B 7/14

(52) U.S. Cl. 455/19

(57) ABSTRACT

In a low power satellite broadcasting system, recovery of weak received signals is facilitated by combining a highly efficient compression technique such as Advance Audio Coding (AAC) used in MPEG-4 with relatively low rate coding and error correction techniques such as Recursive Systematic Convolutional Turbo Coding with Forward Error Correction (FEC). These techniques are further combined with signal spreading techniques such as Direct Sequence Spread Spectrum Code Division Multiple Access (DSSS CDMA) or Coded Orthogonal Frequency Division Multiplex (COFDM) to spread the signal over a large frequency range for uplink, there permitting multiple users to share the same spectrum while avoiding interference with others, and also mitigating frequency selective fading and multipath. Recovery of the relatively weak signals may be further facilitated by the use of low noise amplifiers and conformal retrodirective phased array antennas, and by broadcasting the same information over two time-delayed channels or from two satellites, adding further redundancy in order to eliminate dropouts.

This application claims the benefit of provisional U.S. patent application Ser. No. 60/424,605, filed Nov. 7, 2002.

### BACKGROUND OF THE INVENTION

1. Field of Invention

This invention relates to an apparatus and method of digital broadcasting using earth orbiting satellites, and in particular to an apparatus and method that enables more efficient use of the bandwidth available to low power satellites, such as C-band satellites.

The invention expands options for utilizing existing earth orbiting satellites, ranging from video down to simple messaging, by enabling mobile and fixed-location users over most of the earth to receive relatively low power broadcasts from the satellites, without the need for dish antenna installations. It uses existing signal processing techniques, including compression, low rate coding, error correction, and spectrum spreading that can easily be implemented at uplink centers, and in receivers by using VLSI chip technology. However, unlike current satellite broadcast systems, the satellite broadcast system of the invention combines the signal processing techniques in ways that emphasize weak signal recovery rather than bandwidth conservation.

In a preferred embodiment of the invention, recovery of weak received signals is facilitated by, for example, combining a highly efficient audio compression technique such as Advanced Audio Coding (AAC) with relatively low rate coding and error correction techniques such as Recursive Systematic Convolutional Turbo Coding with Forward Error Correction (FEC). These techniques are preferably further combined with signal spreading techniques such as Direct Sequence Spread Spectrum Code Division Multiple Access (DSSS CDMA) or Coded Orthogonal Frequency Division Multiplex (COFDM) to spread the signal over a large frequency range for uplink, thereby permitting multiple users to share the same spectrum while avoiding interference with others, and also mitigating frequency selective fading and multipath. Recovery of the relatively weak signals may be further facilitated by the use of low noise amplifiers and conformal retrodirective phased array antennas, as well as by broadcasting the same information over two time-delayed channels or from two satellites, adding further redundancy in order to eliminate dropouts.

2. Description of Related Art

C-band offers a relatively large bandwidth having good propagation characteristics and an existing satellite network with global coverage. However, current broadcasting techniques, designed primarily for spectrum conservation, are ill-suited to C-band broadcasts, which are limited by power constraints rather than bandwidth, and therefore can only reach stationary users with relatively large dish antennas. As a result of the proliferation of fiber and development of the K-Band spectrum, the C-band satellite network is currently underutilized, even while companies invest enormous sums in new broadcast satellite networks and compete for other portions of the electromagnetic spectrum.

The present invention approaches the problem of reaching mobile users, and others without relatively large dish antennas, by seeking to recover the weak signals broadcast by C-band satellites in a more efficient manner through an improved signal design, implemented in uplink processors and receivers. In particular, the invention combines state-of-the-art digital compression techniques with error correction that add redundancy to the broadcast signal, thereby facilitating the reception of weak signals while still maintaining acceptable spectral efficiency by signal spreading. No other broadcasting application requires this combination of compression, coding, and signal spreading techniques.

The reason for the low power of C-band broadcasts is that it operates in a band that can cause interference with terrestrial RF broadcasts. The C-band satellite network, which currently includes more than 100 operational satellites globally, was specifically designed to broadcast relatively low power (˜37 to 42 dBW) signals that could only be picked up by properly oriented dish antennas, thereby eliminating the possibility of interference with RF receivers lacking such antennas. However, spectrum spreading and coding techniques have made it possible to share spectrum with multiple users, thus opening up the possibility of using C-band for broadcasts other than satellite television. Nevertheless, the low power of C-band satellites continues to limit use of the satellites.

Broadcasts intended for reception by smaller or mobile antennas, such as satellite radio, have instead been pushed into other frequency bands with less allocated bandwidth (25 MHz for satellite radio, in contrast to 500 MHz for C-band), ensuring that the higher power signals do not interfere with terrestrial broadcasts, but necessitating the launching of more sophisticated, higher power (˜56 dBW) satellites, and therefore substantially raising the cost of establishing a network. The cost of such networks effectively precludes numerous potential uses of the technology, including establishing public and private channels for voice, video, and messaging, Internet downloads, and emergency warning or public service broadcasts.

There is therefore a need for a method and apparatus, and an appropriate signal design, that will enable broadcasting of radio, voice, and other RF signals not only to dish antennas, but also to small, relatively inexpensive mobile receivers, and yet that can use existing low power satellite networks such as C-band or K-band, by overcoming weak signal reception challenges such as dropouts and multipath interference, thereby eliminating the need to launch and maintain a separate high cost, limited bandwidth satellite network.

The technologies used by the invention are, for the most part, existing technologies. For example, the invention may use audio compression and encoding techniques set forth in the Eureka-147 standard (European Telecommunications Standard 300 401), but adapted to provide enhanced recovery of low power signals. Eureka-147 is a European design for digital audio radio, including satellite radio. It has considerable (government) investment and several years development behind it-and thus offers the possibility of avoiding substantial development time and expense. The Eureka-147 design combines many digitized audio channels, then interleaves them in both frequency and time. The carriers are multiplexed (COFDM) and each carrier convolutionally BPSK or QPSK encoded to modulate the main carrier (although it is also possible, at a cost in bandwidth, for the invention to use time domain coding techniques such as Pulse Code Modulation (PCM), Differential PCM (DPCM), Adaptive PCM (ADPCM), and Delta Modulation). COFDM allows independent modulation among carriers (i.e. BPSK, QPSK, etc) so that both can be handled in parallel, with the aggregate signal being transmitted across a wide broadcast band to minimize frequency selective fading.

The present invention modifies the Eureka approach, even as it uses elements of the approach, by using MPEG-4, v.2, and Advanced Audio Coding (AAC), rather than the MPEG-2 Layer II-popularly called Musicam-concept embedded in Eureka-147, by relying primarily on stream mode rather than packet mode (although inclusion of packet mode capabilities is within the scope of the invention, by using Fast Information Block (FIC) data services only for essential control info, and primarily by combining the compression-based audio coding with enhanced error protection that tends to reduce the transmitted data bit rate in favor of more robust signal recovery.

Another existing technique used by the present invention is Turbo-coding, extensively developed in the past half-decade for use in European and Japanese Global System for Mobile Communications (GSM) wireless systems, which offers increased gain over straight Reed-Solomon encoding. The Turbo-coding technique is combined with the above-mention audio coding and with Forward Error Correction (FEC), preferably in the form of a convolution code added at the source and used at the receiver.

The convolutional coding employed by the invention preferably uses low rate coding and a long constraint length. The long constraint length mitigates brief signal dropouts. Decoding, on the other hand, preferably uses soft-decision, maximum likelihood sequential processing. Although this decoding increases system complexity (more shift registers required), it is well within capabilities of today's chip technology. In addition, Unequal Error Protection (UEP) can be used to efficiently provide the highest protection to control information, next to dominant audio components, etc.

Encoding adds redundant information in ways that permit errors to be detected and corrected after transmission through a noisy channel. While spectral efficiency is usually emphasized to conserve spectrum, it can be traded for power, which is especially relevant in this invention. Forward Error Correction (FEC) is particularly critical to compensate for the low power as well as frequent signal dropouts when being received by mobile receivers.

With the ability to trade bandwidth for power in this application, rate ¼ coding will double the gain of the more common rate ½. Use of InGaAs FETs in receiver front ends can reduce noise levels to 0.2-dB, from a normal 2-dB. The cumulative benefit results in C-band audio to mobile receivers with small antennas now being practical. Due to the rapid shifting back and forth between fade and nonfade, a non-coherent demodulation technique may be superior to a coherent technique.

In the preferred embodiment of the invention described herein, several high quality music channels, or a larger number of speech channels, can be broadcast from each commercial C-band satellite transponder to mobile receivers using 6-inch square flat antennas. The ability to operate without need for dish antennas greatly increases the utility of this concept. Currently, even the relatively small K-band dishes are much larger than 6-inches, and must be carefully pointed at the satellite. Thus, using this invention, the 700+ C-band transponders currently serving North America could broadcast over 5,000 music channels. Some of these transponders are presently being offered on short-term basis for around $12,000 per month, for a total satellite cost of less than $2,000 per month per channel for continental coverage.

### SUMMARY OF THE INVENTION

It is a first objective of the invention to enable relatively low power satellite networks, which currently broadcast only to stationary users with dish antennas, to broadcast to both mobile and stationary users, and thereby to open low power satellite networks to such applications as satellite radio, private channel communications, mobile video, messaging, and Internet downloads.

More generally, it is a second objective of the invention to enable more efficient utilization of existing satellite communications bandwidth.

It is a third objective of the invention to use existing lower cost C-band, Ka-band and other existing satellite networks, which currently have excess capacity and a global reach, to provide broadcast services such as satellite radio, telephone, etc., to mobile as well as stationary receivers.

It is a fourth objective of the invention to provide a method and apparatus for low cost satellite broadcasting of radio and voice signals to both stationary and mobile antennas, using transponder space available on existing satellites to minimize capital expenditures.

It is a fifth objective of the invention to provide a satellite broadcasting method and apparatus that reduces dropouts without the need for terrestrial repeaters.

It is a sixth objective of the invention to provide a satellite broadcasting method and apparatus that expands the number of users without affecting existing users.

It is a seventh objective of the invention to provide a satellite broadcasting method and apparatus that uses existing satellites and that can be implemented solely by means of special uplink processors, and receivers using low cost chip sets.

It is an eighth objective of the invention to provide a signal design that combines state-of-the art compression with coding techniques designed to enhance recovery of weak signals.

These objectives of the invention are accomplished, according to the principles of various preferred embodiments of the invention, by a combination of one or more of the following signal processing and broadcast techniques:

a. digital compression;

b. coding and error correction technologies such as, respectively, Advanced Audio Coding (AAC) audio compression, Recursive Systematic Convolutional Turbo Code encoding of the broadcast channel, and Unequal Forward Error Correction;

c. spread spectrum modulation of the uplink carrier, for example by direct sequence CDMA;

d. the addition of a narrow-band CW-modulated pilot tone for downlink synchronization

e. use of redundant signals, either sent from two satellites or with a time delay in applications where terrestrial repeaters cannot be used due to interference from terrestrial signals.

These techniques are applied, in accordance with the principles of a preferred embodiment of the invention, to an uplink method and apparatus that carries out the following uplink steps:

a. the signal to be broadcast is digitized (if analog);

b. the signal is then compressed as appropriate for the application to minimize transmitted information;

c. the compressed signal is encoded to provide reliable transmission through a noisy RF link;

d. the encoded signal is spread to enable spectrum sharing, and

e. the spread, encoded signal is used to modulate the signal uplinked to a satellite.

Further, according to the preferred embodiment of the invention, the following steps are used for detection and recovery of the broadcast signal after relay through the satellite back to earth and detection by receivers utilizing small antennas:

a. the received signal is isolated and passed through a low noise amplifier;

b. the amplified signal is demodulated;

c. the demodulated signal is despread to recover the desired signal;

d. the recovered signal is decoded to correct noise errors introduced in the transmission, and

e. the decoded signal is converted to analog if appropriate for the application.

According to an especially advantageous feature of the preferred embodiment, special consideration is given to providing robust signal synchronization for detecting and decoding the received signal, and to mitigating effects of signal dropouts caused by such factors as terrain masking. Synchronization is achieved by use of active carrier tracking, a simple CW clock, and devoting sufficient bandwidth to provide necessary power, while three techniques, which can be combined as needed, are used to cover dropouts: Forward Error Correction, and redundant transmissions either from a second channel or from another satellite.

Although not intended to be restrictive, the most immediate application of the method and apparatus of the invention is audio broadcasting, using existing geosynchronous C-band satellites operating within their authorized (FSS/BSS) spectrum allocation. The advantage of this application to audio broadcasting is that it greatly expands the number of audio channels available to the public worldwide. In that case, suitable audio compression techniques include Perceptual Audio Coding, and especially Advanced Audio Coding, or AAC as used in MPEG-4. Measured by the number of bits needed to convey audio information, AAC is twice as efficient as the popular “MP3.” Further to enable recovery of weak received signals, data encoding and decoding techniques such as Turbo Coding, and specifically a Recursive Systematic Convolutional Turbo Code, are preferred. These techniques may be combined with a relatively long constraint length, and soft decision sequential decoding using a BCJR algorithm with two maximum a posteriori (MAP) decoders operating cooperatively, can provide performance very near the Shannon limit. RF power considerations dominate spectral efficiency in this application, which favors use of low rate coding (½) and low order phase shift keying such as Binary Phase Shift Keying (BPSK). Finally, signal spreading techniques such as Direct Sequence Spread Spectrum Code Division Multiple Access (DSSS CDMA) are preferably used to spread the signal over a large frequency range to permit many users to share the same spectrum while avoiding interference with others. Spreading also mitigates frequency selective fading and multipath.

As a result of this unique combination of existing broadcasting and signal processing techniques, small antennas providing nearly hemispherical coverage can be employed, avoiding the need to point cumbersome dish antennas. While even a small whip antenna may be used, the preferred receiving antenna is a conformal retrodirective phased array, a passive device that automatically finds the satellite and electronically “points” to it. It is a flat, square array of small crossed dipole elements etched onto a panel and encased in a flexible pad. The desired gain can be achieved by simply adding elements. Low Noise Amplifiers behind the antenna have very low noise figures. Using current technology a 6-inch square C-band design can receive 14 near CD quality music channels from each transponder on a satellite such as Galaxy XR, or 40 speech channels. A 1-foot antenna will quadruple these numbers. The design also readily enables control of reception-whether for subscription services, to comply with local radio regulations, permit private channels, or to identify intellectual property.

In summary, the invention adapts modern digital signal processing techniques-compression, coding and spectrum sharing-to the recovery of weak signals. Technologies combined to achieve this purpose include digital data encoding and decoding, multiple access methods of spectrum sharing, data compression, phased array antennas, low noise amplifiers, and chip manufacturing methods that make necessary data processing power and speed practical. Significantly these techniques are “additive,” and within this framework can be combined to deliver performance suitable for a variety of market needs, including the need make available substantial radio spectrum for global broadcasting, especially to personal and mobile receivers. The invention productively enables direct broadcasting to nearly all the earth from currently operating commercial satellites. In contrast to existing services, which provide only limited data rates or require large dish antennas, this concept allows much higher data rates with small antennas providing nearly hemispherical coverage. It greatly expands utility of a segment of global radio spectrum that has very good propagation characteristics, yet does this without adverse effect on other authorized uses.

As a result, the invention will greatly increase utility of the airwaves, allowing many disenfranchised voices and artists' access to the airwaves. Making hundreds of channels economically available will allow content to be focused much more selectively upon specific markets, and presents a major opportunity to develop new markets, especially in emerging countries. Because of the ability to focus selectively on audiences not previously served by radio broadcasting, advertisers will be attracted from other media. The possibility of delivering many channels to much of the globe will enable reaching demographic segments heretofore impractical to aggregate. As a public service, Emergency Warning and other Public Service Announcements may also be broadcast, preempting other services in relevant areas. GPS receivers may be incorporated to identify relevant geographic areas.

### BRIEF DESCRIPTION OF THE DRAWINGS

FIG. 1 is a schematic diagram of an equivalent circuit of an 8×8 phased array antenna that may be used to receive signals from a C-Band or similar satellite network, in connection with the receiver illustrated in FIG. 2.

FIG. 2 is a schematic diagram of a receiver constructed in accordance with the principles of a preferred embodiment of the invention.

FIG. 3 is a schematic diagram of an uplink processor constructed in accordance with the principles of the preferred embodiment.

FIG. 4 is a table illustrating features of a signal designed according to the principles of the preferred embodiment.

### DETAILED DESCRIPTION OF THE PREFERRED EMBODIMENTS

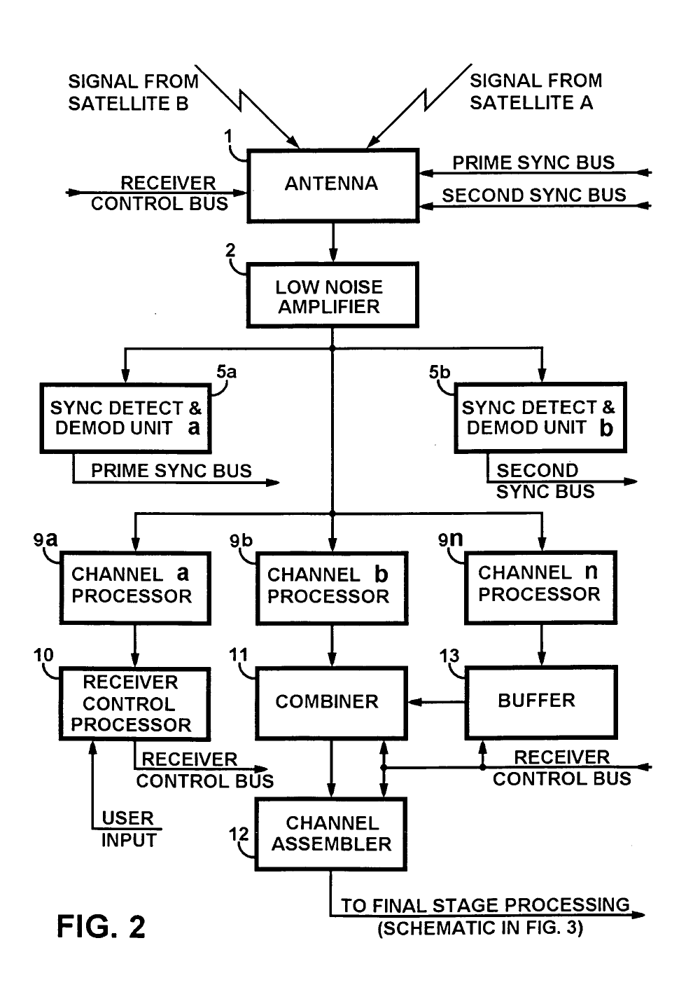

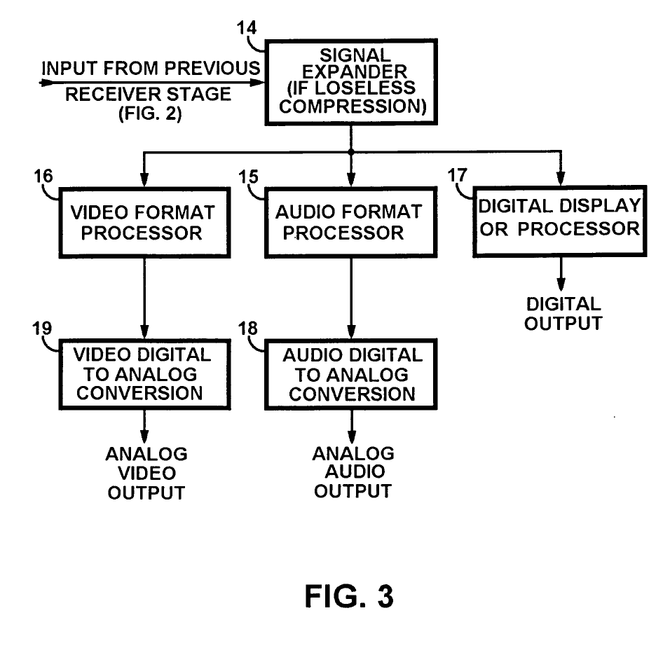

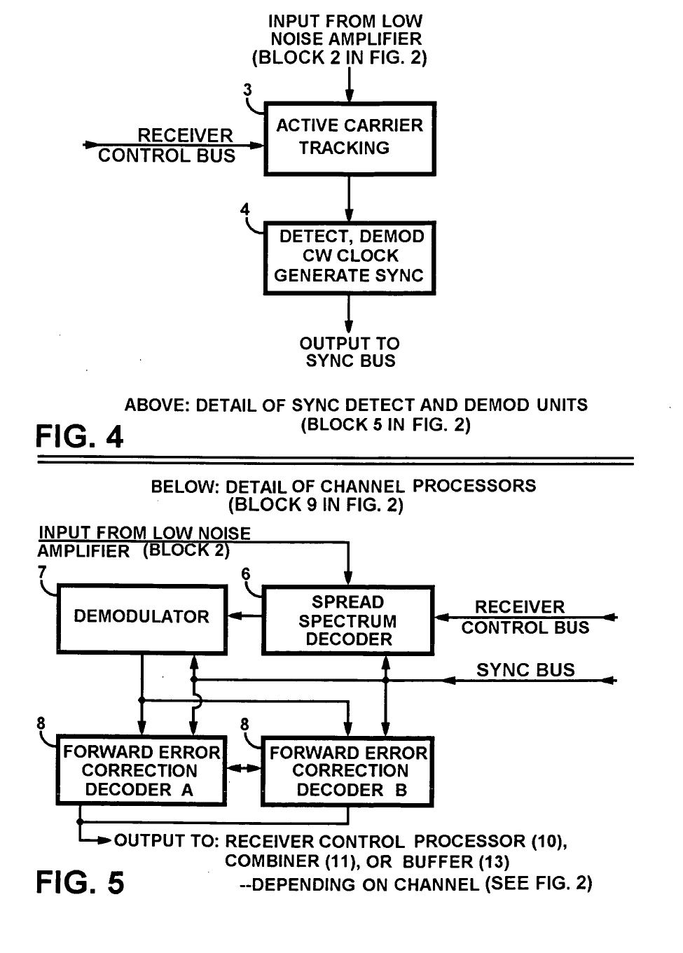

FIG. 2 shows a preferred receiver for use in connection with the satellite broadcast system of the invention. The receiver is especially adapted to recover audio and/or video signals from C-band satellites, although those skilled in the art will appreciate that the invention is not limited to broadcasting of audio or video signals, and that it may be applied to satellite networks other than C-band.

Referring to FIG. 2, radio frequency energy transmitted by the satellite is connected by an antenna 1 and amplified by a low noise amplifier 2. The output of the low noise amplifier 2 is applied to sync detection and demodulation units 5a, 5b, 5c, . . . , each of which includes an active carrier tracking processor 3 and a detection, demodulation, and synchronization processor 4, in order to recover timing signals in the satellite transmission. The timing signals and the original received and amplified signal are then applied to receiver channel processors 9a, 9b, 9c, . . . , each of which includes a spread spectrum decoder 6, demodulator 7, and error correction unit 8, for recovery of the baseband signals. The recovered baseband signals may then be buffered in buffer(s) 13, and when sufficient baseband signals have been recovered, combined in combiner 11 if two or more channels are involved, and processed by channel assembler 12 under control of a control processor 10. The output of the channel assembler 12 is supplied to a signal expander 14, if lossless compression has been used, and finally subjected to audio format processing by a processor 15, video format processing by a processor 16, digital-to-analog conversion and display by respective converters 18 and 19 and display 17, depending on the application.

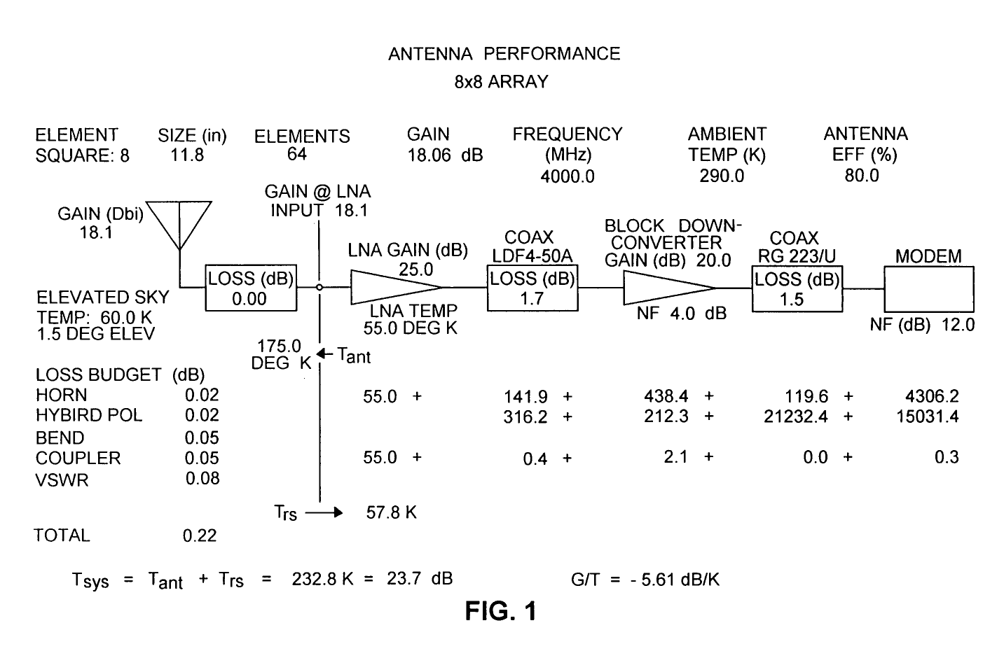

Although not limited to a particular antenna configuration, antenna 1 may take the form of a conformal retrodirective phased array antenna such as the 8×8 phased array antenna schematically illustrated in FIG. 1 and described, for example, in Kaiser, J. A. Retrodirective Antenna Array System, International Telemetry Conference 1995. A conformal retrodirective phased array antenna has no moving parts and need only be pointed within about 65-degrees of the satellite. Physically the antenna is a square flat panel, about an inch thick, and sufficiently flexible that it can be mounted on any moderately curved surface.

In the antenna of FIG. 1, the basic component is the individual crossed dipole, a design which is replicated in each element of the array. This antenna is designed for C-band frequencies and will work with any signal design, making it compatible with future signal design improvements. Horizontal dimensions of the antenna are variable, with larger sizes collecting more RF energy. The size selected for the most common applications is about 6-inches square, small enough to be inconspicuously located on vehicles or even used in a backpack. At C-band a 6-inch antenna will contain 16 dipole elements; a higher performance 9-inch antenna will contain 36 elements. The antenna is able to receive signals from two separate satellites simultaneously if both are within its field of view, which is an optional mode of operation used for some applications, as described below.

The low noise amplifier 2, as the name indicates, amplifies the received signal immediately behind the receiving elements, without adding noise and before thermal noise is introduced by the system electronics. The preferred embodiment uses an Indium Gallium Arsenide High Mobility Electron Field Effect Transistor (In GAS HMET FET), one for each of the antenna elements.

Sync detectors 5a,5b include active carrier tracking processors 3 to minimize signal acquisition and reacquisition times. Processors 3 detect and track (lock onto) a narrow-band pilot tone transmitted in the center of each satellite transponder. The pilot tone is then supplied to processor 4 which detects and demodulates a CW clock tone to generate a sync pulse.

At least one active carrier tracking and sync generating set of processors 3 is required for each satellite from which a signal is being received, as well as for each transponder not synchronized with others on the same satellite. In the illustration sync processor unit 5a processes the sync for the primary satellite, while sync processor unit 5b serves the same purpose for an unsynchronized second transponder, or for a second satellite if one is being used.

As well be explained in greater detail below, the preferred signal format involves a spread spectrum encoding technique that enables multiple users to share spectrum without interference. The spread spectrum signal from the antenna 1 and low noise amplifier 2 is fed into the spread spectrum decoder 6 to yield the desired channel. The preferred embodiment uses direct sequence spread spectrum code division multiple access (DSSS CDMA), although other spread spectrum encoding techniques may also be used, depending on the application. The receiver control processor 10 provides the decoder with the code for the desired channel, and the sync generators 5a,5b provide the sync pulses.

Demodulators 7 of receiver channel processors 9a,9b,9c,9d demodulate the despread signal from the decoders 6, and output the desired channel. The output signal from each respective demodulator 7 is then processed by the forward error correction decoder 8 to provide forward error detection and correction. As described in more detail below, the preferred embodiment uses two Maximum A Posterori Decoders 8 operating cooperatively, shown as decoders A and B, and decodes the signal using a BCJR algorithm.

A separate, identical receiver channel processor is required for each channel being received at any one time. In the illustrated embodiment, receiver channel processor 9a is used for the receiver control channel, processor 9b is used for the primary data channel, processor 9c is used for a signal received from a second satellite, and one or more receiver channel processors 9d et al are used for other purposes, such as for emergency or public service information.

All receiver functions and operations are controlled by or through the receiver control processor 10. The user inputs the desired channel, along with other information such as desire and geographic area for emergency warning announcements. This configuration information is stored in buffers and programmable gate arrays, and used to configure other receiver processors. Authorization to receive subscription channels or private channels is received via the broadcast signal, as are reception authorizations in compliance with national and international regulations.

The combiner 11 coherently adds the same desired channel when it is obtained from two (or more) receiver channels, such as 9b and 9c. If data is missing from one channel, the sum becomes just the other channel(s). The optional channel assembler 12 then buffers and assembles data packets as necessary, i.e., if the signal has been packetized, prior to final processing of the baseband signal recovered from the receiver channel processors, determining which will be sent on to the user. It receives configuration information from the receiver control processor 10.

Normally data from the primary channel, channel 9b in this illustration, will be used. However, as explained below, this same information may also be broadcast over a second channel from the satellite at a time slightly earlier than the primary signal for the purpose of filling in signal interruptions resulting from such conditions as terrain masking. The same signal may also be broadcast from another satellite for the same purpose-providing a signal from a different direction into the receiver. In this example, the supplemental signal is processed by channel 9c. If the channel assembler 12 detects missing information in the primary channel, it will seek this missing information from these alternate sources. Emergency warning and other public service announcements may also be broadcast over the system. If these announcements are applicable for the area where the user is located (according to information entered into the receiver control processor by the user or provided by an integral GPS receiver), this announcement will preempt the primary channel. The remaining channels, Channel 9d, 9e, etc, can be used for such purposes.

The buffer 13 temporarily stores the signal from a parallel channel that is transmitted ahead of the primary channel through the same satellite, generally to fill in missing segments in the primary channel due to such factors dropouts caused by as masking. It is synchronized with the primary channel and subsequently sent to the combiner 11 to be added to the primary signal.

If compression has been used, as in the preferred signal embodiment, the signal expander restores the compressed signal back to its original form, based on information supplied through the receiver control channel to the receiver control processor 10.

Finally, the signal is displayed or output through an appropriate display or output 17, and/or an audio format processor 15 restores the signal to a format suitable for subsequent conversion into analog audio, while a video format processor 16 restores the signal to a format suitable for subsequent conversion into analog video, depending on the type of signal received, and the respective digital-to-analog converters 18,19 convert the respective signals to analog as necessary for display or playback. These final processing and display elements 15-19 may be entirely conventional and form no part of the present invention except insofar as the invention uniquely permits small mobile receivers to be used to receive satellite broadcasts (e.g., a “pocket” satellite radio).

Those skilled in the art will appreciate that the receiver functions of receiving the satellite signal, demodulating the received signal, establishing bit and frame synchronization, deinterleaving, and decoding the convolutionally encoded data may all be engineered into a VLSI chip design, making quantity production costs low, and resulting in a small, low-power, reliable unit. Although the receiver may be sold in several forms-for different applications and interfaces-the same basic chip can be incorporated in each.

The illustrated C-band receiver may be tuned to the 36-MHz band of a specific transponder on a satellite. As is well-known, each receiver can be made individually addressable through a receiver management channel-permitting subscription service. Management information, including subscription authorization, may be carried either in a separate additional channel or appended to each channel. Each ITU national entity can have its own unique code, permitting control of countries in which reception of a particular broadcast is permitted. Intellectual property identification of broadcast content may also be transmitted, enabling management control. Optional, the receiver can be arranged such that emergency broadcasts will, at subscriber option, pre-empt selected programming if applicable to the area in which the receiver is located.

The receivers can be designed as multi-channel receivers, simultaneously processing say both an 8-kbps channel and a 24-kbps channel. Operationally the 8-kbps channel, using wideband CELP coding, might be used for speech channels (news, talk shows, etc.), thus increasing the number of channels carried. The 24-kbps channel can be used for full-audio programs. The 8-kbps and 24-kbps channels could be combined to provide 2-channel stereo, taking advantage of the redundancy in stereo. Alternatively, the normal commercial FM scheme, multiplexing “Left+Right” audio on a carrier and “Left−Right” on a subcarrier, could be adopted.

Although the terminology “receiver” is generally used herein, the proper terminology for many applications might be “tuner.” A tuner performs most of the same signal processing functions as does a receiver, except usually does not include audio amplifiers or speakers-the larger, power hungry components. The tuner output must be played into a receiver or other sound system to be audible. This is indeed the approach others have adopted-linking into an available sound system using an input device such as a cassette tape deck, or by wireless (low power broadcasting into the antenna of an available receiver) . XM Radio is now advertising their tuner as a “plug and play receiver.”

While it is envisioned that most audio receiver designs will include small speakers, provision will be incorporated to interface this receiver output with existing sound systems available to listeners. Connections may be made to “radio cards” inserted into cassette or CD slots in automotive radios. To facilitate user operability, this interface can be wireless. For example, in automotive applications, use of a very low power transmitter operating in the upper end of the commercial FM band can input directly into the vehicle's existing audio system, permitting use of the latter's speakers and volume controls. This is the approach widely employed in devices such as baby monitors today. The above-mentioned Eureka-147 encoding scheme, for example, includes provisions for an IBOC (In-Band On-Channel) implementation in which signal levels must be below specified masks, generally a minimum of 25-dB down. Wireless interfaces in other bands such as CB may also be considered.

In addition to conventional radio formats, the digital signal broadcast by the satellite may be packetized, for example by using a User Datagram Protocol (UDP) connectionless protocol with only forward error checking and no resequencing or flow control, modified by addition of a sequence block (such as a simple time tag). It would be desirable for the receiver to process two or three different rates, permitting service to both those wishing high quality music and providing lower bandwidth (and cheaper) delivery of news, sports, etc.

As mentioned above, a valuable auxiliary feature made possible by the invention, and that is relatively simple to incorporate, is the capability of pre-empting selected programming with emergency warning announcements. The listener's location can be programmed into a PGA in the receiver. All emergency announcements would be carried on a public service channel, along with identification of affected areas. If the receiver is in an affected area, the announcement would pre-empt selected programming. A GPS (Global Positioning System) interface may be incorporated to enable automatic input of location into the receiver, or more probably, a GPS core will be added directly in the receiver chipset.

Uplink processing, illustrated in FIG. 3, is largely the reverse of the receiver processing illustrated in FIG. 2. In operation, only a few uplink processors will be needed, and these will not be power or size limited. Also, skilled maintenance personnel will be available to maintain and calibrate these uplink systems.

The various functional blocks of an uplink processor that corresponds to the receiver of FIG. 2 are briefly explained below in connection with FIG. 3, and then explained in more detail in connection with a discussion of the signal design. The hardware utilized can be entirely conventional, with all of the various compression, encoding, modulation, and transmitting functions being carried out by software or firmware programmed into microprocessors or VLSI chips.

Referring to FIG. 3, the uplink processor first digitizes the baseband signal (in block 1) to be broadcast. For example, if the baseband is audio, it may be digitized by sampling at the Nyquist rate and PCM quantized at 16-bits per sample. This uplink signal is next compressed (block 2), using perceptual audio coding (MPEG-4 Advanced Audio Coding (AAC)). Punctured convolutional coding may be employed to permit use of both Equal Error Protection (EEP) and Unequal Error Protection (UEP). The baseband signal is then encoded (block 3) for Forward Error Correction (FEC), using Turbo Coding (specifically, a Recursive Systematic Convolutional (RSC) Turbo Code), with a Parallel Concatenated Convolutional Code (PCCC). Coding will use a rate of 1% and a length of 15. Spectrum sharing is accomplished by adding Direct Sequence Spread Spectrum Code Division Multiple Access (DSSS CDMA) in block 4. This encoded signal then modulates the satellite uplink, using binary phase shift keying (BPSK). A narrow-band pilot tone, typically 3-5 Hz, 1-watt, transmitted in the center of the transponder band (block 5) provides the tracking angle information needed to electronically steer the phased array antenna, as well as to remove doppler and provide the sync signal needed for signal detection. This composite signal is then uplinked to a satellite, and re-broadcast back to earth.

A possible modus-operandi for the uplink system is that radio content would be sent via full period terrestrial circuits to a central point. This central location would probably be a commercial teleport such as Denver. At this location signals from all stations would be digitized, aggregated, encoded, and uplinked to the appropriate transponder on a commercial satellite(s). Existing major facilities near Perth and Fucino would likely provide sites for Africa, Asia, Australia and European broadcasting gateways.

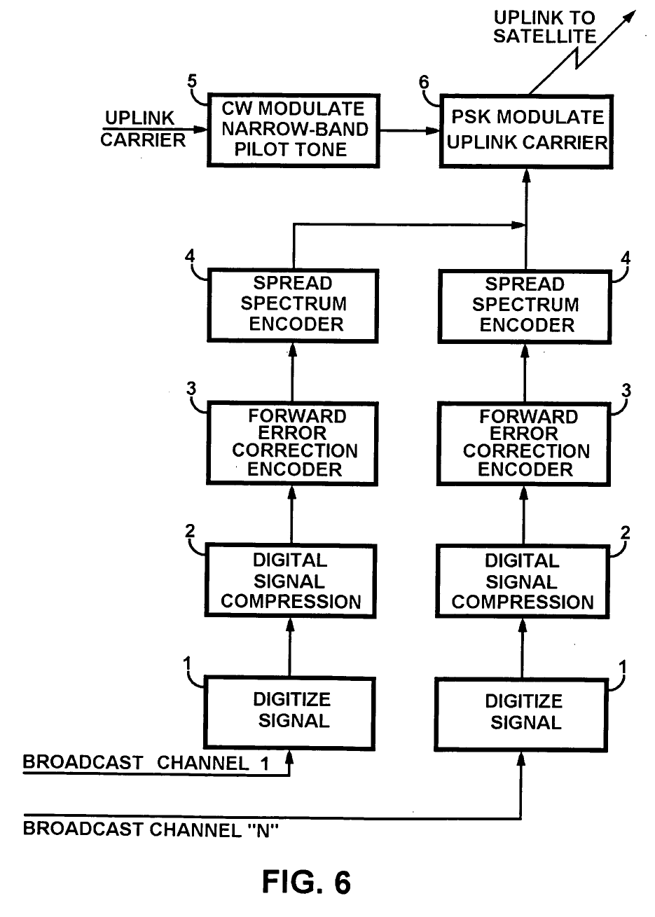

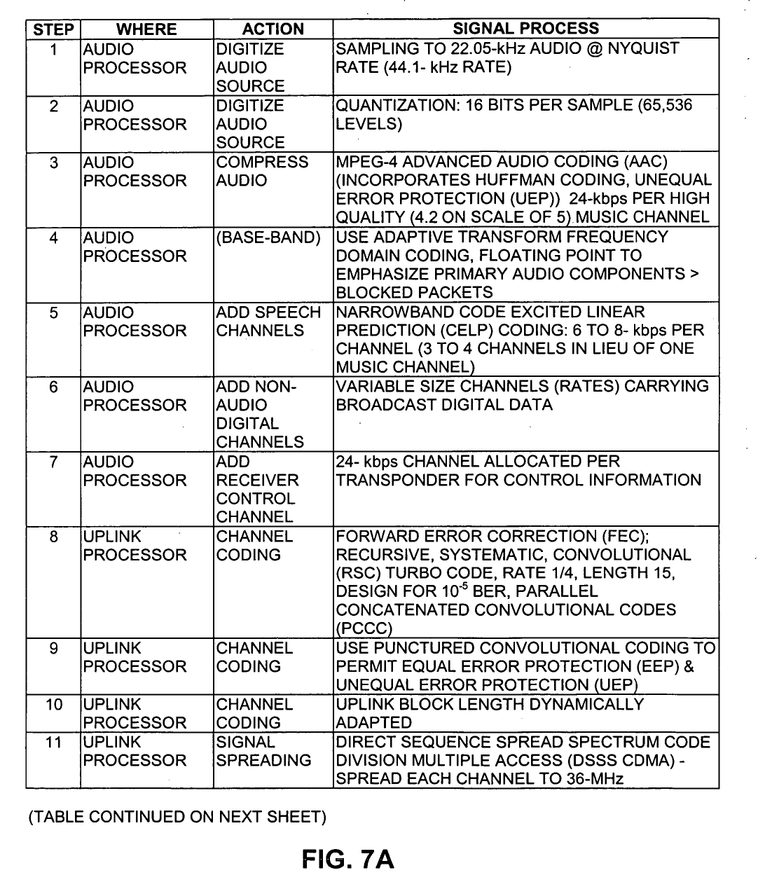

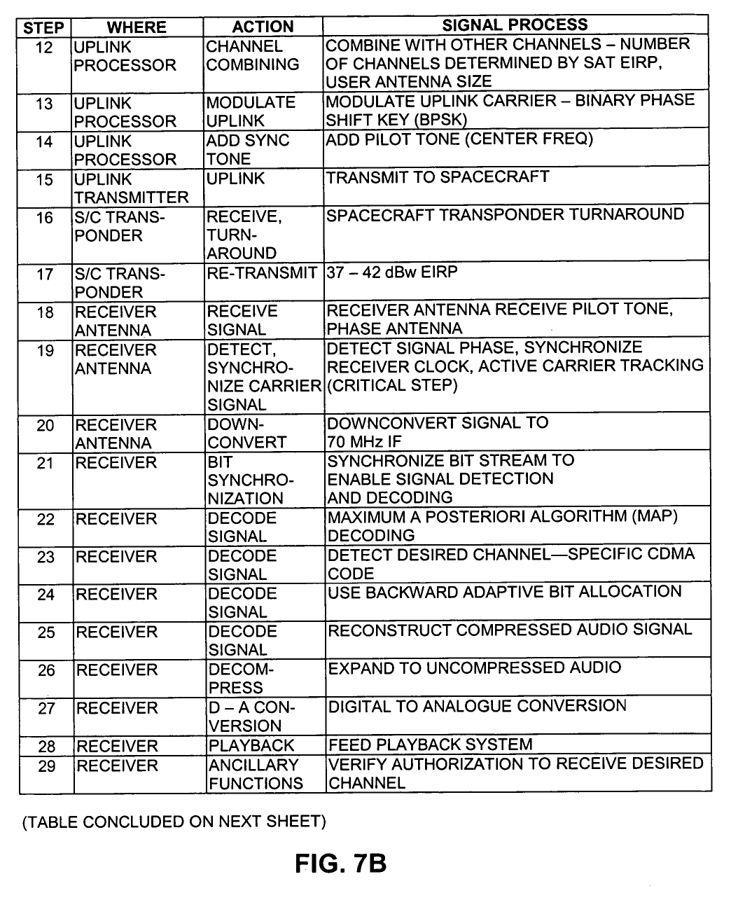

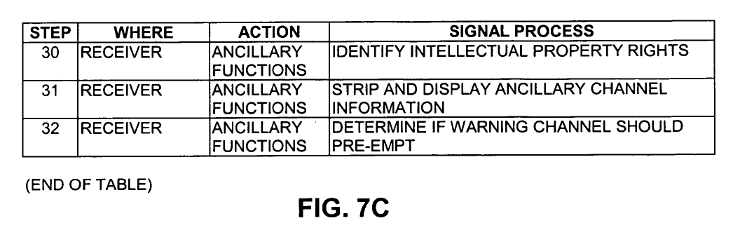

A preferred audio signal design will now be described in connection with FIG. 4. It will of course be appreciated that the same or similar techniques may be applied to video, and that the invention is not limited to audio signals or to the exact compression, encoding, and/or modulation techniques discussed below.

The preferred design for audio combines a perceptual audio coding technique, BPSK modulation, Turbo-coding, Direct Sequence Spread Spectrum Code Division Multiple Access (DSSS-CDMA), and Maximum a Posteriori (MAP) decoding to provide over 28 channels of high quality satellite radio per transponder using a 1-foot receiving antenna. The signal processing flow is shown in FIG. 4. The system can deliver more channels by using multiple transponders, or alternatively by using a larger receiving antenna. Insofar as practical and cost-effective, the design is adapted from the Eureka-147, Transmission Mode III design, with the addition of Turbo coding, redundant signal transmissions, and other adaptations to the low power environment of C-band.

Compression of the original digital or digitized audio signal is carried out according to MPEG-4 with Advanced Audio Coding (AAC). In this coding scheme, frequency-domain transform coding is used to adaptively quantize only perceptually significant parts of the audio signal. Additional compression results from using a floating point format, by assigning bits according to audibility, and the use of Huffman coding. Backward Adaptive Bit Allocation and Code Excited Linear Predictive (CELP) Silence Compression also may be used. Thus quantization can be reduced from 16-bit PCM words per sample to less than 2-bits, resulting in AAC's ability to code audio signals at 24-kbps per channel with little perceptible degradation from original high fidelity audio sources.

Preferably, the error robustness tools of MPEG-4, such as Unequal Error Protection (UEP), are also incorporated. A Cross-Interleave Reed-Solomon (CIRS) code (the same code standardized for CD's) may also be employed for added Forward Error Correction (FEC). Other Eureka-147 features, such as Parametric Audio Coding, Synthesized Sound, Environmental Spatialization, and Back Channel Communication, would add little value in this application.

After the audio signal is perceptually coded, it is input into the signal processing system as a 24-kbps per mono channel digital signal. The resulting baseband signal is then Turbo Coded, specifically with a Recursive Systematic Convolutional (RSC) Turbo Code and a Parallel Concatenated Convolutional Code (PCCC). This approach uses Forward Error Correction (FEC), along with interleaving, to protect against burst errors. Because of digital heritage, performance is normally described in terms of a Bit Error Rate (BER) which treats all bits as equally important. Rate ¼, length 15, encoding can provide an effective Bit Error Rate of 10⁻⁵ using Unequal Error Protection. As in the Eureka-147 design, punctured convolutional coding will be employed in this case to permit use of both Equal Error Protection (EEP) and Unequal Error Protection (UEP). EEP will be used for receiver control information; UEP will be applied to the audio channels, giving more protection to the dominant audio components.

The reason that rate ¼ encoding is selected is because it provides increased coding gain, important in the low signal-noise ratio environment. Although rate ¼ is used infrequently because of the increased bandwidth needed for a given thru-put data rate, the basic technique is a simple variation of the widely used rate ½ encoding. Again, rate ¼ capitalizes on the wider bandwidth available here-and in fact spreading the signal wider avoids interference both to and from other systems operating in the same band. Rate ¼, length=15 encoding was successfully used in NASA's Galileo spacecraft, transmitting data from Jupiter.

Once the signal has been encoded for error correction, the signal is spread spectrum encoded and then used to phase modulate a carrier. The preferred modulation method, as discussed above, is Binary Phase Shift Keying (BPSK). BPSK is selected in preference to higher order PSK (Phase Shift Keying) techniques such as QPSK to provide better performance in a relatively low signal level environment. While theoretical BPSK performance is 1-bit/Hertz, practical performance is about 0.7-bits/Hertz-effectively increasing predetection bandwidth by about 40%.

Spread spectrum encoding of the error correction encoded signal may be accomplished by any of a number of known techniques, including Coded Orthogonal Frequency Division Multiplex, used by Eureka-147, or Direct Sequence Spread Spectrum Code Division Multiple Access (DSSS CDMA), commonly used in cellular telephone networks. For many applications, Direct Sequence CDMA will be the preferred approach to spectrum sharing since CDMA is resistant to multipath and fading in mobile applications, and the number of audio channels can easily be increased within the selected bandwidth, each added channel causing only a slight increase in the noise floor due to Inter-Symbol Interference (ISI). CDMA is also resistant to specular and diffusion multipath as these slightly delayed (delay spread) signals are dropped in the process of despreading the direct signal component. A disadvantage of CDMA is that CDMA does require control of relative power levels among users sharing the same spectrum, but this condition is easily controllable in this application.

Each high fidelity music channel in this example consists of a 24-kbps audio signal, including auxiliary channel specific information. After rate ¼ coding, the 24-kbps rate increases to 96-kbps per channel. Using 0.7-bps/Hz BPSK efficiency, the bandwidth is 140-kHz per channel. Speech channels are at 8 or 16-kbps. These channels will then be spread over 36-MHz, with all channels sharing the same spectrum using Code Division Multiple Access.

The receivers of the preferred embodiment are tunable to any of the twenty-four 36-MHz transponders carried on most commercial C-band satellites, and to odd 72-MHz transponders used on a few satellites, thus allowing the system to utilize available transponders globally. A narrow-band, 1-watt pilot tone transmitted in the center of the transponder band will provide the tracking angle information needed to electronically steer the phased array antenna, as well as to remove doppler and provide the sync signal needed for signal detection. The antenna and the receiver demodulator must have sufficient signal for carrier recovery and bit synchronization. This vital process is achieved by devoting necessary bandwidth and power. Techniques such as Active Carrier Tracking (ACT), discussed above in connection with FIG. 2, have achieved resynchronization within about 10 bits.

Decoding, following adaptive carrier tracking synchronous detection to obtain the sync signal for carrier recovery and bit synchronization, is preferably carried out in the receiver by soft decision sequential decoding. Sequential decoding is selected in preference to the more commonly used Viterbi algorithm because it offers better BER performance. Soft decision processing generally offers a 2-dB improvement and, given the chip implementation and performance, the added complexity is acceptable. A maximum likelihood sequential decoding algorithm may be used to reduce computation complexity in view of the long constraint length employed to protect against dropouts. Necessary processing speed and buffer size are practical with today's technology.

Reception in the multipath and fading environments encountered during mobile reception, especially in urban and hilly areas, requires special attention when designing and implementing the broadcast signal. The mobile propagation environment is characterized by both signal reflections and deep fades (Rician fading will dominate Rayleigh fading) caused by blockage and reflection of the satellite signal by objects such as trees, buildings and other obstacles. The fades will frequently be so deep that the signal falls below practical link margins. Coding and time interleaving are normally used to protect against this condition. The proper choice of coding complexity and interleaving depth are very important. Analyses show that lower rate convolutional codes result in better performance under severe blockage conditions, although require more bandwidth. Longer time interleaving also protects against signal dropout, but involves more memory (complexity) in the receiver and increases re-acquisition times.

Computer simulations by Horan indicate dropouts, defined as fades greater than 5 dB, will be short: 95% of the dropouts will be less than 2 msec when driving at road speed (55 mph), 5 msec at urban driving speeds (25 mph), and 27 msec when walking at 3 mph. The simulations show: as the speed increases, the fade duration decreases but the non-fade duration also decreases. As a result, the optimal time shift for a mobile receiver will be a function of speed, and therefore the time shift may need to be chosen to best help a particular user profile.

Due to the rapid shifting back and forth between fade and non-fade, a non-coherent demodulation technique may prove superior to a coherent one. Although Forward Error Correction (FEC) techniques can bridge many of these gaps, the actual duration of the drops must be extended to include the carrier recovery time. Non-coherent demodulation may therefore provide better performance under this condition. Especially promising is a technique known as “adaptive carrier tracking synchronization,” by which Feher reports QPSK demodulator resynchronization in less than 10 bits.

Although not technically a signal design issue, another solution to mitigating dropouts is broadcasting the same information over two channels, the second delayed relative to the first. A variation of this approach in mobile applications is to simultaneously broadcast from a second satellite to provide a second view angle. This of course increases satellite costs and requires the receiver to process two channels in parallel, buffering one as described above. Channel state information can then be used in the combiner to add the channels or select which channel to use for audio output.

The two-satellite approach takes advantage of the different signal masking profiles coming from two different satellites, and subsequently adds the signals in the combiner. This combination illuminates the antenna from two very different directions, greatly reducing masking. The antenna can receive dual signals simultaneously. The two signals are synchronized (approx 10-msec max difference) , buffered, and sent to the combiner. A central uplink location permits uplink to both east and west satellites from a single location. For example, PamAmSat's Galaxy XR at 123° W and XI at 91° W could both be accessed from the Denver Teleport.

In order to implement the two satellite approach, current VLSI design techniques permit multiple channels to be received and processed in parallel in a single chip set. GPS receivers, using Direct Sequence Spread Spectrum, employ this concept for multiple signals from different satellites, processing them in parallel in a multi-channel receiver. The present invention may also use multi-channel receivers combined into a single package by causing two channels on the same transponder to transmit the same channel twice-the second channel delayed slightly. A buffer can easily accommodate the delay to permit synchronizing the two signals and combining them to provide the best signal. (Portable CD players offer a similar “skip protection,” with buffers of 120-seconds in low cost players.) This basic scheme readily offers protection against longer dropouts, by simply using larger buffers.

In operation the antenna/receiver system will function as follows. The system is given a satellite/transponder ID based on listener input from a menu. The ID is stored in the receiver, and updated thru the receiver control channel as needed. This ID supplies the desired pilot tone frequency to the antenna, and the corresponding 36-MHz band and appropriate CDMA code to the receiver. (Different frequency pilot tones may be used to differentiate among transponders transmitting the same frequency from different satellites.) The antenna phase locks to the desired carrier signal, after which the LNA down-converts the signal to, typically, a 70-MHz IF signal for transmission to the receiver.

Receiver configuration is controlled both by listener input and the downlink receiver control channel. The primary control mechanism is provided by configuring the receiver to process a specific CDMA code. Associated with this code is the type of channel, which in turn sets such parameters as video, audio or data, data rate, type of error protection, etc. In the case of a multi channel receiver, each channel is configured separately. Each transponder broadcasts a receiver control channel defining all its current channels. It will also address individual receivers with subscription authorizations and changes. Listener input is primarily channel selection, and secondarily such preferences as emergency channel interrupt. The receiver configuration is set using Programmable Gate Arrays, which will maintain the selected configuration until they are reset. The receiver control channel may be shared among all active transponders on a given satellite.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A method of uplinking a digital signal to an earth orbiting satellite so as to facilitate reception of the signal by receivers using small antennas providing wide angle coverage, comprising the steps of:
a. encoding the digital signal to provide reliable transmission through a noisy RF link;
b. modulating the encoded digital signal for uplink to a satellite; and
c. adding synchronization information to the digital signal uplinked to the satellite to facilitate detection and recovery of the transmitted signal by a receiver.

2. A method as claimed in claim 1, further comprising the step of spreading the encoded signal over a wide frequency band prior to uplinking to avoid interference with other authorized users in the band.

3. A method as claimed in claim 1, further comprising the step of compressing the digital signal to minimize transmitted information by removing redundant or less significant information.

4. A method as claimed in claim 1, wherein a baseband signal is analog, and further comprising the step of digitizing the signal by sampling the signal in the time or frequency domain, and quantizing the values.

5. A method as claimed in claim 4, wherein Pulse Code Modulation (PCM) is used to digitize the signal.

6. A method as claimed in claim 4, wherein the baseband signal is audio, and wherein the step of compressing the digital signal comprises compressing the digital signal by a perceptual audio coding technique to remove sounds inaudible to the human ear.

7. A method as claimed in claim 6, wherein the step of compressing the digital signal further employs the process of Advanced Audio Coding (AAC) as used in MPEG-4.

8. A method as claimed in claim 1, wherein step a. comprises the step of encoding the digital signal by means of a Block or a Convolutional Code.

9. A method as claimed in claim 1, wherein step a. includes the step of interleaving the data to minimize burst errors.

10. A method as claimed in claim 1, wherein step a. comprises the step of Turbo Coding the digital signal.

11. A method as claimed in claim 10, wherein the step of encoding the digital signal is further by means of a Recursive Systematic Convolutional Turbo Code.

12. A method as claimed in claim 1, wherein step a. comprises the step of encoding the digital signal using a relatively long constraint length.

13. A method as claimed in claim 1, further comprising the step of spreading the coded digital signal over a large frequency range by Direct Sequence Spread Spectrum Code Division Multiple Access (DSSS CDMA).

14. A method as claimed in claim 1, wherein step b. further comprises the step of modulating the digital signal by phase shift keying.

15. A method as claimed in claim 1, wherein step c. further comprises the step of adding a synchronization channel to the digital signal uplinked to the satellite to facilitate receiver signal synchronization.

16. A method as claimed in claim 1, wherein step c. further comprises the step of adding a narrow-band pilot tone to the digital signal uplinked to the satellite to facilitate receiver signal synchronization.

17. A method as claimed in claim 1, wherein step c. further comprises the step of adding a clock signal using CW modulation of the digital signal uplinked to the satellite to facilitate receiver signal synchronization.

18. A method as claimed in claim 1, further comprising the step of redundantly broadcasting the uplinked digital signal over two channels, one with a time delay, or from two satellites to mitigate dropouts.

19. A method as claimed in claim 1, further comprising the step of spreading the coded digital signal over a large frequency range by COFDM.

20. A method as claimed in claim 1, wherein the satellite is a C-band satellite.

21. A method as claimed in claim 1, further comprising the step of including identification of geographical areas affect by emergency warning or public service announcements in the uplinked digital signal.

22. A method of processing a digital signal received from an earth orbiting satellite so as to facilitate reception of the signal by small antennas providing wide angle coverage, comprising the steps of:
a. isolating and passing the received digital signal through a low noise amplifier;
b. recovering sync signals in the isolated digital signal;
c. demodulating the isolated digital signal;
d. despreading the demodulated signal; and
e. decoding the demodulated signal to correct noise errors introduced during transmission.

23. A method as claimed in claim 22 wherein the signal is further decompressed if it has been compressed and decompression is appropriate for the application.

24. A method as claimed in claim 22, wherein step b. comprises the steps of demodulating a CW clock and using active carrier tracking to recover the sync signals.

25. A method as claimed in claim 22, wherein step e. comprises the step of soft decision sequential decoding using a BCJR algorithm with a maximum a posteriori decoder, or with two maximum a posteriori decoder operating cooperatively.

26. A receiver for use in receiving satellite broadcasts, comprising:
a small antenna providing nearly hemispherical coverage;
a low noise amplifier connected to amplify a signal received by the antenna;
a sync detection and demodulation unit connected to recover timing signals from an amplified signal output by the low noise amplifier;
a plurality of receiver channel processors connected to the low noise amplifier and the sync detection and demodulation unit, each channel processor including a spread spectrum decoder, a demodulator, and an error correction decoder, for recovering baseband signals.

27. A receiver as claimed in claim 26, wherein said satellite broadcasts are C-band satellite broadcasts.

28. A receiver as claimed in claim 26, capable of receiving and processing redundant signals that are time-delayed signals or signals broadcast by different satellites.

29. A receiver as claimed in claim 26, wherein said antenna is a phased array antenna.

30. A receiver as claimed in claim 29, wherein said antenna is a conformal retrodirective phased array antenna.

31. A receiver as claimed in claim 29, wherein the antenna is a square flat flexible panel.

32. A receiver as claimed in claim 29, wherein each element in the phased array is a crossed dipole.

33. A receiver as claimed in claim 26, wherein said amplifier includes a Field Effect Transistor.

34. A receiver as claimed in claim 33, wherein said amplifier includes a High Mobility Electron Field Effect Transistor for at least one element of said antenna.

35. A receiver as claimed in claim 34, wherein said amplifier includes an Indium Gallium Arsenide High Mobility Electron Field Effect Transistor.

36. A receiver as claimed in claim 26, wherein said sync detection and demodulation unit includes an active carrier tracking processor.

37. A receiver as claimed in claim 36, wherein said sync detection and demodulation unit further includes a sync processor for detecting and demodulating a CW clock tone to generate a sync pulse.

38. A receiver as claimed in claim 36, wherein one said sync processor processes a sync signal for a primary transponder, and a second said sync processor processes a sync signal for an unsynchronized second transponder on the same or another satellite.

39. A receiver as claimed in claim 26, wherein the spread spectrum decoder is a Direct Sequence Spread Spectrum Code Division Multiple Access decoder.

40. A receiver as claimed in claim 26, wherein the error correction decoder includes a Maximum A Posterori decoder, or two Maximum A Posterori decoders operating cooperatively.

41. A receiver as claimed in claim 40, wherein the error correction decoder or decoders are arranged to use a BCJR algorithm.

42. A receiver as claimed in claim 26, wherein a number of said channel processors is equal to a number of channels being received at any one time.

43. A receiver as claimed in claim 26, wherein a first said receiver channel processor is used for a first primary data channel, a second said receiver channel processor is used for a second primary data channel, and a third said receiver channel processor is used for one of a time-delayed redundant signal and a signal received from a second satellite.

44. A receiver as claimed in claim 26, wherein at least one additional said receiver channel processor is used to process emergency or public service information.

45. A receiver as claimed in claim 26, further comprising a channel expander for decompressing the baseband signal.

46. A receiver as claimed in claim 26, further comprises a channel assembler for assembling data packets output by the combiner if the satellite broadcast includes packetized data.

47. A receiver as claimed in claim 26, further comprising at least one processor selected from the group consisting of an audio format processor and a video format processor.

48. A receiver as claimed in claim 26, further comprising a GPS receiver chip arranged to automatically update receiver geographic position so that when a broadcast of emergency or public service information is detected, regular operation of said receiver may be preempted if said receiver is within an area affected by said emergency or public service information.

49. A receiver for use in receiving C-band satellite broadcasts, comprising:
a small antenna providing nearly hemispherical coverage;
a low noise amplifier connected to amplify a signal received by the antenna;
a sync detection and demodulation unit connected to recover timing signals from an amplified signal output by the low noise amplifier; and
a plurality of receiver channel processors connected to the low noise amplifier and the sync detection and demodulation unit, each channel processor including a spread spectrum decoder, a demodulator, and an error correction unit, for recovering baseband signals,
wherein said antenna is a conformal retrodirective phased array antenna.

50. A receiver for use in receiving C-band satellite broadcasts, comprising:
a small antenna providing nearly hemispherical coverage;
a low noise amplifier connected to amplify a signal received by the antenna;
a sync detection and demodulation unit connected to recover timing signals from an amplified signal output by the low noise amplifier; and
a plurality of receiver channel processors connected to the low noise amplifier and the sync detection and demodulation unit, each channel processor including a spread spectrum decoder, a demodulator, and an error correction unit, for recovering baseband signals,
wherein a first said receiver channel processor is used for a first primary data channel, a second said receiver channel processor is used for a second primary data channel, and a third said receiver channel processor is used for one of a time-delayed redundant signal and a signal received from a second satellite.

51. A receiver as claimed in claim 50, wherein at least one additional said receiver channel processor is used to process emergency or public service information.

52. A C-band broadcast signal consisting of a digital signal that has been encoded to provide Forward Error Correction, spread over a large frequency band, and used to modulate a satellite uplink carrier.

53. A C-band -broadcast signal as claimed in claim 52, wherein the C-band broadcast signal is compressed by frequency domain transform coding, and the frequency domain transform coding is MPEG-4 with Advanced Audio Coding.

54. A C-band broadcast signal as claimed in claim 52, wherein said encoding for Forward Error Correction uses a Recursive Systematic Convolution Turbo Code.

55. A C-band broadcast signal as claimed in claim 54, wherein said encoding for Forward Error Correction is carried out at rate ¼.

56. A C-band broadcast signal as claimed in claim 52, wherein said spreading is carried out using Direct Sequence Code Division Multiple Access encoding.

57. A C-band broadcast signal as claimed in claim 52, wherein said modulation is carried out by Phase Shift Keying.

58. A C-band broadcasting method comprising the step of using multi-channel receivers arranged to receive redundant signals, said redundant signals including one of a time-delayed redundant signal and a redundant signal received from a second satellite.
